(19) United States
(12) Patent Application Publication
(10) Pub. No.: US 2026/0340379 A1
(43) Pub. Date: Oct. 29, 2026

(54) EFFICIENT TRAINING OF MULTI-MODAL LANGUAGE MODELS

(71) Applicant: NVIDIA Corporation, Santa Clara, CA (US)

(72) Inventors: Piotr Zelasko, Wellington, FL (US); Zhehuai Chen, Odessa, FL (US); Mengru Wang, San Jose, CA (US); Daniel Galvez, Palo Alto, CA (US); Oleskii Hrinchuk, Santa Clara, CA (US); Shuoyang Ding, Long Island City, NY (US); Ke Hu, Stony Brook, NY (US); Jagadeesh Balam, Campbell, CA (US); Vitaly Lavrukhin, Campbell, CA (US); Boris Ginsburg, Sunnyvale, CA (US)

(21) Appl. No.: 19/189,820

(22) Filed: Apr. 25, 2025

(51) Int. Cl. G06N 3/08

(52) U.S. Cl. CPC G06N 3/08

(57) ABSTRACT

Disclosed are apparatuses, systems, and techniques that implement interleaved multi-modal training for training of language models. The techniques include selecting training data of a first modality to generate a first training batch and selecting training data of a second modality to generate a second training batch. The techniques further include processing, using a language model (LM), the first training batch to learn a first modification of parameters of the LM, processing, using the LM, the second training batch to learn a second modification of the parameters of the LM, and changing the one or more parameters of the LM based at least on the first modification and the second modification.

### TECHNICAL FIELD

At least one embodiment pertains to computing resources used to perform and facilitate various speech and text processing tasks performed with machine learning, including, without limitation, conversational artificial intelligence (AI), automatic speech recognition, and automatic speech translation. For example, at least one embodiment pertains to the use of language models to facilitate and improve the translation of speech and/or text from one language to another language.

### BACKGROUND

Speech recognition, also known as automatic speech recognition (ASR), is an intersection of computer technology and linguistics directed to techniques of recognition and translation of spoken language into text that can be displayed on a screen, output as synthesized speech, printed, stored, used as an input into a conversational model, as an instruction, or in any other way. ASR systems often deploy machine-learning models (MLMs), e.g., trained neural networks, to recognize patterns of speech in a particular language and identify units of speech, such as phonemes, graphemes, words, subwords, sentences, and the like. ASR systems are commonly deployed in user-facing applications, such as virtual agents, live captioning, clinical notetaking, and the like, and can be trained using speech samples produced by multiple speakers to accurately process different language dialects and accents. Automatic speech translation (AST) is a technology that converts words, phrases, and sentences spoken in a first language into the corresponding speech units in a second language. AST can be performed using ASR to transcribe the spoken words into text followed by machine translation of the transcribed text into the second language or by directly converting spoken words to the second language. ASR and AST are parts of the speech-to-text (S2T) group of technologies. Various S2T systems and techniques can be used alone (e.g., to generate transcriptions and/or other records of speech—such as to synthesize new speech) or in conjunction with various text-to-speech (T2S) algorithms (e.g., to carry out natural language conversations). Other automatic speech tasks facilitated by machine learning include speaker identification that involves associating spoken utterances with speakers whose speech samples are stored in a database of speakers (or detecting a new speaker not represented in the database), speaker verification that involves determining whether two or more utterances are spoken by the same speaker or different speakers, speaker diarization that includes partitioning unstructured speech among various participants of a conversation or meeting, and/or other tasks.

### BRIEF DESCRIPTION OF DRAWINGS

FIG. 1A is a block diagram of an example computer system capable of performing interleaved multi-modal training of language models, according to at least one embodiment;

FIG. 1B illustrates an example computing device that supports interleaved multi-modal training of language models and/or deployment of trained language models, according to at least one embodiment;

FIG. 2A illustrates example operations of a multi-modal language model (MMLM) trained using interleaved multi-modal training, according to at least one embodiment;

FIG. 2B illustrates example operations of another MMLM trained using interleaved multi-modal training, according to at least one embodiment;

FIG. 2C illustrates example operations of training an MMLM using interleaved multi-modal training, according to at least one embodiment;

FIG. 3A illustrates example operations of interleaved multi-modal training with random selection of input modalities, according to at least one embodiment;

FIG. 3B illustrates example operations of interleaved multi-modal training with aggregation of modifications of model parameters, according to at least one embodiment;

FIG. 3C illustrates one illustrative example of training data randomization that may be performed as part of training of MMLMs and other AI models, according to at least one embodiment;

FIG. 4A illustrates training data size binning that may be used in interleaved multi-modal training, according to at least one embodiment;

FIG. 4B illustrates batch size optimization that may be used in interleaved multi-modal training, according to at least one embodiment;

FIG. 5 is a flow diagram of an example method of using interleaved multi-modal training for training of language models, according to at least one embodiment;

FIG. 6 is a flow diagram of an example method of batch size optimization that may be used in interleaved multi-modal training, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment;

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Language models (LMs), including large language models (LLMs), small language models (SLMs), vision language models (VLMs), multi-modal language models (MMLMs), etc., have achieved remarkable success in a variety of natural language processing tasks, including supporting conversations in natural language, understanding speaker's intent and emotions, explaining complex topics, generating new texts/images/audio/etc. upon receiving suitable prompts, writing and debugging software codes, providing advice regarding topics of interest to a user, and/or performing other functions. LMs typically undergo self-supervised training on massive amounts of text (and/or other data, such as audio, image, video, 2D or 3D graphics or design, etc.) data and learn to predict next and/or missing words in a phrase/sentence, detect intent and/or sentiment of a human speaker, determine if two sentences are related or unrelated, and/or perform other basic language tasks. Following the initial training, LMs often undergo instructional (prompt-based) supervised fine-tuning that causes LMs to acquire more in-depth language proficiency and/or master more specialized tasks, such as learning financial market literacy, solving mathematical problems, and so on. Fine-tuning can be supervised, e.g., with learning prompts (questions, hints, etc.) accompanied by example texts (e.g., answers, sample essays, etc.) used as ground truth that LMs try to emulate. Later stages of fine-tuning may also include reinforcement learning, when a human grader assigns marks indicating a degree to which the generated texts resemble human-produced text. Existing LMs demonstrate in-context learning ability from a low number of representative examples, even when similar examples have not been seen by the LMs in the previous training.

These learned abilities of LMs are also attractive for extension to other (than typed text) input modalities, including speech (audio) modalities. For example, an LM can be trained to perform automatic translation directly from speech (audio) inputs. Training of such multi-modal LMs (MMLMs) typically involves pre-training a foundational LM to perform text-to-text (T2T) translations from a first language to a second language, extending the pre-trained foundational LM with an audio encoder network capable of receiving audio inputs, and then training the extended foundational LM to process speech inputs in the first language to perform S2T translations (AST) to the second language. Such training with new modality (speech) inputs, however, usually results in significant (“catastrophic”) forgetting or at least noticeable deterioration of the model's T2T skills. The existing approaches aimed at prevention of such forgetting include using adapters, e.g., low-rank adapters (LoRAs), which are added to a frozen (following the T2T pretraining) LM. Namely, during a subsequent S2T training, parameters of the foundational LM remain fixed (to prevent forgetting), while parameters of the lightweight adapter are learned to add speech skills to the model's acumen. Such an approach has a number of limitations. For one, the use of adapters makes the model's architecture more complex and also makes re-training (or fine-tuning) using new text and/or speech training data (e.g., to extend the model's proficiency to a new knowledge domain) more difficult. Furthermore, adapters with a relatively modest number of neural nodes tend to achieve a rather limited proficiency in S2T tasks, especially in hard cases that involve rare/unusual words and phrases. Larger adapters may improve performance to a degree, but increase architectural complexity even more and significantly increase the total training time and costs.

Aspects and embodiments of the present disclosure address these and other technological challenges by providing for interleaved training techniques for training of multi-modal language models and/or other multi-modal AI systems. More specifically, a multi-modal LM (MMLM) may be trained with data of multiple input modalities (e.g., text and speech, text, speech, and images, and/or other combinations of input modalities) used during the same training epochs with various parameters (e.g., weights and biases) of the MMLM being changed according to modifications computed in response to processing of training multi-modality inputs.

In some examples, a batch of training data (a set of training inputs processed by the MMLM in a single setting) may include text training inputs or speech training inputs, randomly selected from available repositories of training data. Following processing of a particular batch of a randomly selected modality (e.g., text), parameters of the MMLM may be adjusted (e.g., according to gradients computed using the results of processing of the selected batch) before a next batch of another randomly selected modality is chosen. Initial probabilities of selection of batches of different modalities, e.g., P_{TEXT} and P_{SPEECH}, may beset based on a number of available batches of training data, N_{TEXT} and N_{SPEECH}, of each modality, e.g., P_{TEXT}=N_{TEXT}/(N_{TEXT}+N_{SPEECH}) and P_{SPEECH}=N_{SPEECH}/(N_{TEXT}+N_{SPEECH}). As the training epoch progresses, and one of the modalities is consumed faster than the other modality, the probabilities of selection of the remaining training data may be adjusted accordingly (e.g., the rate of selecting training batches of a faster depleted modality decreased with the rate of selecting the other modality increased) such that batches of both modalities are used up fully by the end of a given training epoch. In another example, one or more batches of the text modality and one or more batches of the speech modality may be processed and the computed gradients may be stored after processing each batch before being aggregated (e.g., added) together and applied to the parameters of the MMLM to implement multi-modal gradient aggregation.

In some embodiments, batches of training data may be prepared with input/output length optimization. For example, when training inputs of different lengths are present in a given training batch, shorter inputs have to be padded (e.g., with null input values) to the length of longer inputs. As a result, processing devices (e.g., GPUs, accelerators, etc.) have to perform a large number of null operations (e.g., multiplications and additions of zeros) to process the padded values. Distributing training inputs with substantially similar lengths into respective buckets or bins and using inputs from the same (or close) bins reduces the amount of time spent processing null inputs. Additionally, training of some MMLMs may include combining inputs (e.g., translation prompts) with target outputs (e.g., correct translations) within a single batch. Sizes of such target outputs may correlate weakly (or not at all) with the sizes of target inputs. Accordingly, a training engine performing batching may define bins Bᵢⱼ in a two-dimensional space of input sizes j and target sizes k so that batches of training data are formed from training inputs and target outputs of similar dimensions, to minimize padding and processing of padded portions of the input data.

The number of training inputs in an individual batch may vary from bin to bin, with fewer training data units from bins with longer training inputs/target outputs fitting into a single batch than of units selected from bins with shorter inputs/outputs. To determine an optimal amount of training data fitting into a single batch, a certain number of input/output dummy units N₁ correspondent to an input/output bin Bᵢⱼ may be selected for a test run. Dummy units may be filled with random (dummy) data and—being added to a dummy batch—run on a processing device in a normal fashion, e.g., with the forward pass, loss function computation, backward pass, parameter update, and/or other operations being performed. Various hardware metrics (e.g., memory utilization, GPU/CPU utilization, and/or the like) may be measured to determine whether the hardware is underutilized (e.g., a part of GPU memory remaining unused, a GPU operating at less than a target frequency of clock cycles, etc.) or overutilized (e.g., GPU memory overflowing, GPU processing performing at the maximum rate, an attempt to allocate more GPU memory than is available for execution of training is made, etc.). If the hardware is underutilized, another dummy batch may be formed with N₂=αN₁ dummy units (with the increment factor α>1 selected based on field testing) and used in the next test run and so on, Nₖ₊₁=αNₖ. Once hardware overutilization is detected, e.g., during run k, the number of dummy units in the next run may be decreased, e.g., Nₖ₊₁=Nₖ(1−α/2). This process may continue with the optimization engine using progressively finer increments/decrements ±α/n to find the optimal size of a training batch where hardware utilization is close to a target utilization (e.g., 95%) yet does not exceed it. Such optimization may be performed individually for different bins Bᵢⱼ. Even though a 100% utilization of resources may be desirable, in many instances such target utilization may be suboptimal because of various noise factors, including memory fragmentation, unexpected processor or network activity (e.g., in the instances where training is performed on a set of distributed nodes), and/or the like. For example, additional computational overhead may be associated with computing and logging of metrics, and/or other operations that are not directly attributed to training. Correspondingly, in practice it may be useful to reserve a certain overhead amount of resources for such extraneous and/or unexpected activity.

In some embodiments, to ensure that the use of training data of multiple modalities is properly balanced throughout the training process, datasets of individual modalities are read sequentially into (e.g., GPU) memory using a binomial distribution determined by the probabilities P_{TEXT} and P_{SPEECH} (or a multinomial distribution, in the instance of more than two modalities) using a stochastic multiplexer. The multiplexer interleaves multiple training data streams of training data into a single output stream. The use of the multiplexer makes it possible to maintain the same distribution uniformly throughout the duration of the MMLM training with the probabilities P_{TEXT} and P_{SPEECH} proportional to the amounts of training data with respective modalities in the training dataset. Individual streams may be made effectively infinite, such that when a particular data modality is exhausted, the units of data of that modality may be re-shuffled (e.g., for better randomization) and processed again.

The advantages of the disclosed techniques include but are not limited to efficient training of MMLMs and other multi-modal AI systems to process input data of multiple modalities. Training of individual modalities is performed jointly to prevent catastrophic forgetting as the model's skills in processing individual modalities are constantly reinforced and improved during training. The disclosed techniques of multi-modality interleaved training avoid the challenges of multi-stage training and/or the requirement of complex model architecture during training (e.g., adding adapters after the initial training of a foundational model has concluded). The disclosed single-stage multi-modality training is also effective for retraining or fine-tuning the MMLM for use with new knowledge domains and/or cases that involve rare and/or unusual words and phrases. The disclosed multi-modality interleaved training can be applied to any number of different modalities and can work with a wide range of different model architectures, including but not limited to decoder-only models, encoder-decoder models, and/or the like.

### System Architecture

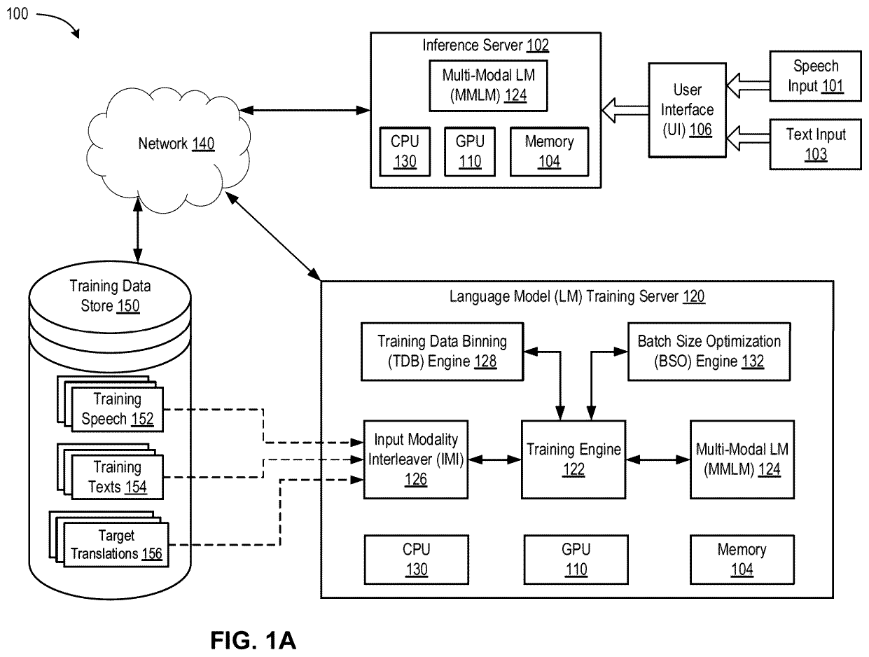

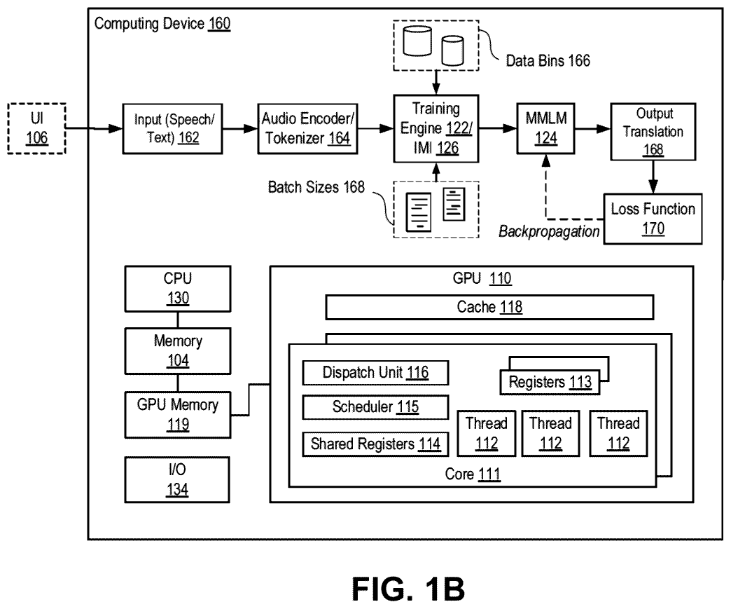

FIG. 1A is a block diagram of an example computer system 100 capable of performing interleaved multi-modal training of language models, according to at least one embodiment. As depicted in FIG. 1A, computer system 100 may include an inference server 102, a language model (LM) training server 120, a training data store 150, which may be connected to a network 140. Network 140 may be a public network (e.g., the Internet), a private network (e.g., a local area network (LAN), or wide area network (WAN)), a wireless network, a personal area network (PA N), a combination thereof, and/or another network type.

Inference server 102 may include a desktop computer, a laptop computer, a smartphone, a tablet computer, a server, a wearable device, a VR/AR/MR headset or head-up display, a digital avatar or chatbot kiosk, and/or an in-vehicle infotainment computing device. Inference server 102 may be configured to receive a speech input 101 and/or text input 103 in a first language and generate an automatic translation of the received input to a second language. Speech input 101 may be associated with any speech episode involving one or more speakers. Speech episodes may include a public or private conversation, a business meeting, a public or private presentation, an artistic event, a debate, an interaction between a digital agent (e.g., chatbot, digital avatar, etc.) and one or more users, an in-vehicle communication (e.g., between two or more occupants, between an occupant(s) and a chatbot, avatar, or digital assistant of the vehicle), a narration, and/or the like. Speech input 101 may include a statement, a query, a question, a request for explanation/tutorial, an expression of emotion, a narrative (or a portion of a narrative), a memorandum, a report, any part of a conversation, and/or any other type of speech that may be produced by a user, including (but not limited to) a human user. In some embodiments, speech input 101 may include speech generated by a computer, e.g., by a text-to-speech (T2S) model, a chatbot, a trained language model, and/or the like. Speech input 101 may be recorded using one or more devices connected to LM training server 120 (e.g., a microphone), retrieved from memory 104 of LM training server 120, and/or received over any local or network connection (e.g., via network 140) from an external computing device. Speech input 101 may be in any suitable format, e.g., WAV, AIFF, MP3, AAC, WMA, or any other compressed or uncompressed audio format.

Text input 103 may include any content expressed in alphanumeric characters, including any letters, numbers, glyphs, punctuation marks, and/or any other suitable symbols expressed in any suitable font or typeset. Text input 103 may include a letter, an article, a post, an instruction, a presentation, a computer program, a statute, a speech transcription, a literary work (or portion thereof), e.g., a book, a poem, a script, and/or any other information that may be expressed in characters or other text form.

In some embodiments, speech input 101 and/or text input 103 may be stored (e.g., together with other data, such as metadata) in training data store 150. Additionally, training data store 150 may store training speech 152 for training one or more models, e.g., an MMLM 124 capable of automatic text translation and/or speech translation from one language to another language, according to embodiments disclosed herein. In some embodiments, MMLM 124 may be capable of translating inputs from any language of a set of one or more input languages to any language of a set of one or more output languages. Training data store 150 may be accessed by inference server 102 directly (e.g., via a bus, interconnect, and/or the like) or (as shown in FIG. 1) via network 140.

Training data store 150 may include a persistent storage capable of storing audio files as well as metadata for the stored audio files. Training data store 150 may be hosted by one or more storage devices, such as main memory, magnetic or optical storage disks, tapes, or hard drives, network-attached storage (NAS), storage area network (SAN), and so forth. Although depicted as separate from inference server 102 and LM training server 120, in at least some embodiments, training data store 150 may be a part of inference server 102 and/or LM training server 120. In at least some embodiments, training data store 150 may be a network-attached file server, while in other embodiments training data store 150 may be some other type of persistent storage, such as an object-oriented database, a relational database, and so forth, that may be hosted by inference server 102 and LM training server 120 or one or more different machines coupled to the corresponding server(s) via network 140.

Inference server 102 and/or LM training server 120 may include a memory 104 (e.g., one or more memory devices or units) communicatively coupled to one or more processing devices, such as one or more graphics processing units (GPU) 110, one or more central processing units (CPU) 130, one or more data processing units (DPU), one or more parallel processing units (PPUs), and/or other processing devices (e.g., field-programmable gate arrays (FPGAs), application-specific integrated circuits (ASICs), and/or the like). Memory 104 may include a read-only memory (ROM), a flash memory, a dynamic random-access memory (DRAM), such as synchronous DRAM (SDRAM), a static memory, such as static random-access memory (SRAM), and/or some other memory capable of storing digital data.

Inference server 102 may deploy MMLM 124 trained using various techniques of the instant disclosure. In some embodiments, MMLM 124 may include an LM trained to process inputs of text modality, speech modality, and/or any other additional modality, e.g., image modality, video modality, sensor modality (e.g., data outputted by one or more physical, chemical, and/or biological sensors), and/or the like. In a speech mode, MMLM 124 may be capable of processing speech input(s) 101. In a text mode, MMLM 124 may be capable of processing text input(s) 103. In a combination (mixed) mode, MMLM 124 may be capable of processing a combination of speech input(s) 101 and text input(s) 103. Prior to being provided to MMLM 124, speech input(s) 101 may be processed by an audio encoder (not shown in FIG. 1A) trained to convert audio data into digital features (audio embeddings) capturing audio content of speech input(s) 101 and contextual interrelationships between different parts of speech input(s) 101. Similarly, prior to being inputted into MMLM 124, text input(s) 103 may be processed by a suitable text tokenizer (not shown in FIG. 1A) configured to convert alphanumeric characters into tokens in a format that represent text input(s) 103 in a way understood by MMLM 124.

Speech input(s) 101 and/or text input(s) 103 may be generated by a user and/or any suitable computer application or a set of interacting computer applications, e.g., an audio application, a video application, a gaming application, a digital assistant application, a communication application, a word-processing application, a speech and/or text generative application, a translation application, and/or any other application that receives, generates (e.g., synthesizes), processes, transmits, and/or otherwise uses speech and/or text. In some embodiments, e.g., in the mixed mode of MMLM 124 operations, speech input 101 may include a speech to be translated while text input 103 may be a prompt entered (e.g., typed) by the same user and/or an application that generated or received speech input 101 and may include a description of a task to be performed by MMLM 124 together with various keywords, phrases, contexts, explanations, and/or the like, associated with speech input 101. In other embodiments, text input 103 may include a text to be translated while speech input 101 may include a prompt with an explanation of the task to be performed (e.g., “translate the attached text of an article about architecture of decoder-only AI models”). In yet other embodiments, both speech input 101 and text input 103 may include information to be translated, e.g., speech input 101 may include an oral portion of a conference presentation and text input 103 may include a slide portion of the presentation.

In one example embodiment, speech input 101 and text input 103 may be received via any suitable user interface (UI) 106, which may include one or more devices of various modalities. For example, speech input 101 may be received via an audio device, e.g., a microphone, and text input 103 may be received via a keyboard, a touchscreen, a touchpad, a writing pad, a scanner, a camera, a graphical interface, a mouse, a stylus, and/or using any other pointing device capable of selecting words/phrases, e.g., being displayed on a screen, and/or some other suitable device. In some embodiments, speech and non-speech input devices may be separate detachable devices, e.g., a microphone of a digital camera, to receive speech input 101 and a computer keyboard to receive text input 103. In some embodiments, speech and text input devices may be integrated together (e.g., into a smartphone, tablet computer, and/or the like). In some instances,

In at least one embodiment, various components of MMLM 124, e.g., encoder, decoder, audio encoder, classifiers, and/or other deployed components may be implemented as deep learning neural networks having multiple levels of linear and non-linear operations. For example, each or some of the deployed models may include convolutional neural networks, recurrent neural networks, fully-connected neural networks, long short-term memory (LSTM) neural networks, neural networks with attention, e.g., transformer neural networks, combination of a convolutional network and one or more transformers (a conformer network), and/or neural networks of other types. In at least one embodiment, any, some, or all deployed models may include multiple neurons, with an individual neuron receiving its input from other neurons and/or from an external source and producing an output by applying an activation function to the sum of weighted (using trainable weights) inputs and, possibly, a bias value. In at least one embodiment, one or more deployed models may include multiple neurons arranged in layers, including an input layer, one or more hidden layers, and/or an output layer. Neurons from adjacent layers may be connected by weighted edges. In some embodiments, LM training server 120 may train multiple different models, which may be models that differ by a number of neurons, number of neuron layers, specific neural architecture, and/or the like.

LM training server 120 may use training speech 152 to train MMLM 124, e.g., to identify parameters (neural weights, biases, parameters of activation functions, etc.) of MMLM 124 in a way that maximizes accuracy of various T2T and S2T tasks performed by MMLM 124. LM training server 120 may be hosted by (and/or include) a rackmount server, a router computer, a desktop computer, a laptop computer, a smartphone, a tablet computer, a server, a media center, and/or any suitable computing device or any combination thereof capable of performing the techniques described herein. In some embodiments, LM training server 120 may be implemented using one or more libraries and/or frameworks for training and deployment of machine learning models, e.g., PyTorch libraries, TensorFlow libraries, NVIDIA® TensorRT™ software development kits, NVIDIA® NIM microservices, NVIDIA® NeMo conversational AI cloud toolkits, NVIDIA® Riva multilingual speech and translation microservices, and/or other systems, toolkits, and/or the like. In some embodiments, any, some, or all machine learning tools may be located on a cloud. In at least one embodiment, LM training server 120 and inference server 102 may be implemented on a single computing device.

In some embodiments, training of MMLM 124 may be supervised, e.g., performed using various target (ground truth annotations) translations 156 of training speech 152 and/or training texts 154. In other embodiments, training speech 152 and/or training texts 154 may be used for unsupervised training, semi-supervised training, training with reinforcement learning, and/or other types of training.

Training speech 152 may be stored in a training data store 150 in a raw audio format, e.g., in the form of spectrograms, or in any other suitable representation of speech. For example, a spectrogram of training speech 152 may be obtained by recording air pressure caused by the speech as a function of time and computing a short-time Fourier transform for overlapping time intervals (frames) of a set duration. This maps the audio signal from the time domain to the frequency domain and generates a spectrogram characterizing the spectral content of training speech 152. The amplitude of the audio signal may be represented on a logarithmic (decibel) scale. In some embodiments, the obtained spectrograms may be further converted into mel-spectrograms, by transforming frequency f into a non-linear mel domain,

$$f \to m = a ln ( 1 + \frac{f}{b} ) ,$$

to take into account the ability of a human ear to better distinguish between equally spaced frequencies (tones) at the lower end of the frequencies of the audible spectrum than at its higher end. In one example, a=1607 and b=700 Hz. Throughout this disclosure, the term “speech spectrogram” may be understood to include Fourier spectrograms, mel-spectrograms, wavelet spectrograms, time-domain filterbanks, custom filterbanks, learnable filterbanks, custom audio embeddings, and/or other forms of analog or digital intermediate audio representation, or some combination thereof.

Training speech 152 and/or training texts 154 may be used by a training engine 122 of LM training server 120 as training inputs to train one or more networks deployed by MMLM 124 to translate spoken words of the training speech 152 or tokens of training texts 154 into a different language. During training, training engine 122 may identify patterns in the training inputs based on target outputs and train various networks of MMLM 124 to perform T2T translations, S2T translations, and other language tasks, and/or other suitable AI tasks. Initially, parameters (e.g., edge weights and biases) of various networks of MMLM 124 may be assigned some starting (e.g., random) values. For example, a training input may include training speech 152 and/or training text 154 in a first language, and a training output generated by MMLM 124 may include training translations in the second language, e.g., text translations. The training translations in the second language may be compared with target outputs, e.g., target translations 156. Training engine 122 may then compare the training output(s) with the desired target output(s). The resulting error or mismatch, e.g., the difference between the target output(s) and the training output(s) of the neural networks, may be back-propagated through various networks of MMLM 124, and the weights and biases in the neural networks may be adjusted to move the training outputs closer to the target (ground truth) outputs. This adjustment may be repeated until the output error for a given training input satisfies a predetermined condition (e.g., falls below a predetermined value). Subsequently, a different training input may be selected, a new output generated, and a new series of adjustments implemented, until the respective neural networks are trained to a target degree of accuracy or until the neural network(s) converges to a limit of its accuracy, which may depend on specific architecture and complexity (e.g., a number of neurons) of MMLM 124. In some embodiments, MMLM 124 may be implemented using a large number (e.g., billions) of artificial neurons, including but not limited to deep learning neural networks equipped with a self-attention mechanism (such as transformer neural networks).

In some embodiments, prior to learning translation skills, MMLM 124 may undergo foundational training (pre-training) to capture syntax and semantics of human language, e.g., by predicting the next, the previous, and/or a missing word in a sequence of words (e.g., one or more sentences of a human speech or text). MMLM 124 may also be trained using training data containing a large number of texts, such as human dialogues, newspaper texts, magazine texts, book texts, web-based texts, and/or any other texts.

Translational ability acquired by MMLM 124 during training may be subsequently evaluated (validated or tested) using additional evaluation or validation inputs. The trained MMLM 124 may then be deployed on inference server 102 for processing of new (not previously encountered) speech inputs 101 and/or text inputs 103.

LM training server 120 may include one or more modules and engines that implement various techniques of the instant disclosure. In some embodiments, LM training server 120 may include an input modality interleaver (IMI) 126 that randomly or deterministically selects training inputs of different modalities (e.g., training speech 152, training texts 154, etc.) to generate respective batches of training data, e.g., speech input batches and text input batches. In some embodiments, IMI 126 may form mixed input batches that include both speech units and text units of training data. In some embodiments, as illustrated in FIG. 1A, IMI 126 may include target outputs, e.g., target transcriptions 156, into input data processed by MMLM 124.

In some embodiments, LM training server 120 may include a training data binning (TDB) engine 128 to distribute training inputs (e.g., training speech 152 and/or training texts 154) into bins of similar dimensions for more efficient processing of training inputs. In some embodiments, LM training server 120 may further include a batch size optimization (BSO) engine 132 to perform simulation processing of dummy data to determine optimal batch size for various bins (e.g., as may be defined by TDB engine 128), for improved utilization of processing and memory resources of LM training server 120.

FIG. 1B illustrates an example computing device 160 that supports interleaved multi-modal training of language models and/or deployment of trained language models, according to at least one embodiment. In at least one embodiment, computing device 160 may be part of LM training server 120 (with reference to FIG. 1A). In at least one embodiment, computing device 160 may be part of inference server 102. In at least one embodiment, computing device 160 includes one or more engines, modules, and/or components to perform interleaved training of MMLM 124, e.g., training engine 122, input modality interleaver (IMI) 126, audio encoder/text tokenizer 164, loss function 170, and/or other components not explicitly shown in FIG. 1A. Computing device 160 may be capable of processing an input 162, which may include speech and/or text and generate an output translation 168 for the input 162. Although speech and text are the two primary input modalities described herein, this is not intended to be limiting, and other additional or alternative input modalities (e.g., image data, sensor data, simulation data, universal scene descriptor (USD) data—such as OpenUSD data, audio data, design data—such as computer aided design (CAD) data, and/or other date types may be used without departing from the scope of the present disclosure. In some embodiments, the output translation 168 may be (or include) a text translation. In some embodiments, the output translation 168 may be or include a speech translation, e.g., generated by processing a trained text-to-speech model to the generated text translation using cascade processing or similar techniques. Although speech and text are the two primary output modalities described herein, this is not intended to be limiting, and other additional or alternative output modalities (e.g., image data, sensor data, simulation data, universal scene descriptor (USD) data—such as OpenUSD data, audio data, design data—such as computer aided design (CAD) data, and/or other date types may be used without departing from the scope of the present disclosure. For example, in some embodiments, the output may include a multi-modal output, where text and/or speech may be output along with simulation data—such as data for simulating a digital avatar or other character type to visually mouth the output text/speech while also performing other motions/movements. In such an example, the system may be used for interactive conversation between a human user and a digital avatar or chatbot, or may include a digital to digital conversation—such as between two non-player characters in a game.

In one example, input 162 may include a speech input (e.g., speech input 101 with reference to FIG. 1A) received over any audio device (e.g., a microphone) in real time or a previously recorded audio input that includes speech. The audio device may be a part of a UI 106 that may further include non-audio devices, e.g., a keyboard, a touchscreen, a writing pad, and/or the like, to receive a text portion of (multi-modal) input 162. In some embodiments, speech and/or text portion of input 162 may include a speech and/or a text to be translated and may further include suitable speech and/or text instructions about the task to be performed by MMLM 124. For example, a speech portion of input 162 may include an audio of a lecture while a text portion of input 162 may include a deck of slides used in the lecture. Any or both of the speech portion and/or the text portion may include instructions (a prompt) to MMLM 124, e.g., “The input includes an audio portion and a slide portion of a conference presentation in the English language. Please prepare a translation of both portions into the Chinese language.” Any or both of the speech portion and/or the text portion may also indicate a context associated with input 162, including an area of knowledge related to input 162 (e.g., AI guardrail systems), one or more typed or spoken keywords, phrases, acronyms, and/or the like.

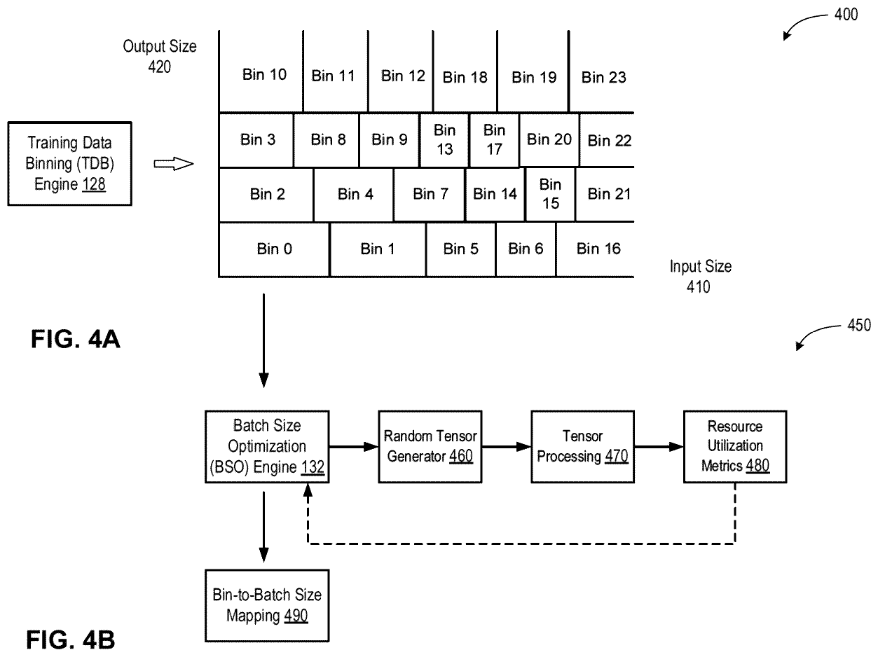

Audio encoder/tokenizer 164 may represent the speech portion (if present) of input 162 via a set of audio embeddings and may further represent the text portion (if present) of input 162 via a set of tokens. During training of MMLM 124 encoded/tokenized input 162 may be combined, e.g., together with other similar inputs 162, into training batches. In some embodiments, training engine 122 may identify, e.g., based on dimension(s) of input 162, a specific bin of data bins 166 (e.g., defined by the TDB engine 128, as described in more detail below in conjunction with FIG. 4A) that corresponds to an interval of dimension(s) of input 162 and may combine input 162 with other inputs from the same bin. In some embodiments, training engine 122 may further access a batch size (e.g., a number of inputs 162 to be combined into a training batch) predetermined (e.g., by the BSO engine, as described in more detail below in conjunction with FIG. 4B) for the bin selected for the input 162. The input 162 may be processed by MMLM 124 that generates an output translation 168. In training, output translation 168 may be evaluated using a loss function 170, which may compare output translation 168 to a target translation with a mismatch between the two translations backpropagated through various neuron layers of MMLM 124 and parameters of the MMLM 124 adjusted in a direction that reduces the mismatch.

Operations of computing device 160 may be executed using one or more GPUs 110, one or more CPUs 130, one or more parallel processing units (PPUs) or accelerators, such as a deep learning accelerator, data processing units (DPUs), and/or the like. In at least one embodiment, a GPU 110 includes multiple cores 111, each core being capable of executing multiple threads 112. Each core may run multiple threads 112 concurrently (e.g., in parallel). In at least one embodiment, threads 112 may have access to registers 113. Registers 113 may be thread-specific registers with access to a register restricted to a respective thread. Additionally, shared registers 114 may be accessed by one or more (e.g., all) threads of the core. In at least one embodiment, each core 111 may include a scheduler 115 to distribute computational tasks and processes among different threads 112 of core 111. A dispatch unit 116 may implement scheduled tasks on appropriate threads using correct private registers 113 and shared registers 114. Computing device 160 may include input/output component(s) 134 to facilitate exchange of information with one or more users or developers.

In at least one embodiment, GPU 110 may have a (high-speed) cache 118, access to which may be shared by multiple cores 111. Furthermore, computing device 160 may include a GPU memory 119 where GPU 110 may store intermediate and/or final results (outputs) of various computations performed by GPU 110. After completion of a particular task, GPU 110 (or CPU 130) may move the output to (main) memory 104. In at least one embodiment, CPU 130 may execute processes that involve serial computational tasks whereas GPU 110 may execute tasks (such as multiplication of inputs of a neural node by weights and adding biases) that are amenable to parallel processing. In at least one embodiment, training engine 122 may determine which processes are to be executed on GPU 110 and which processes are to be executed on CPU 130. In other embodiments, CPU 130 may determine which processes are to be executed on GPU 110 and which processes are to be executed on CPU 130.

### Multi-Modal Speech-Text Processing System

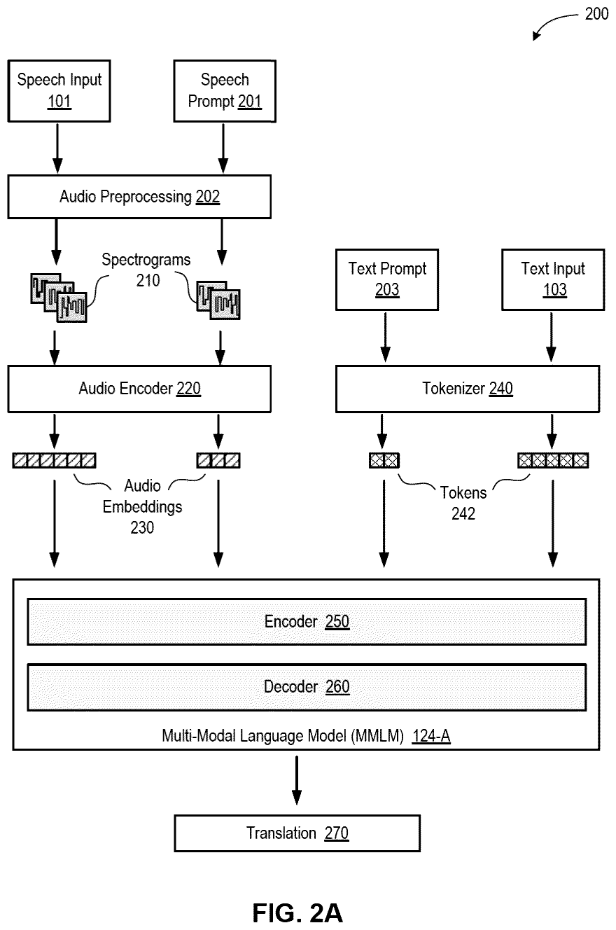

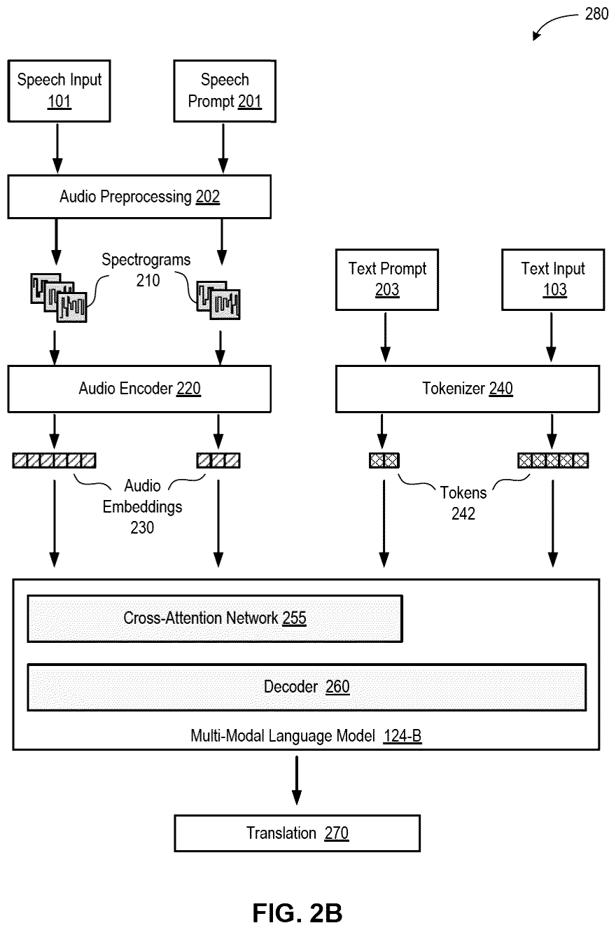

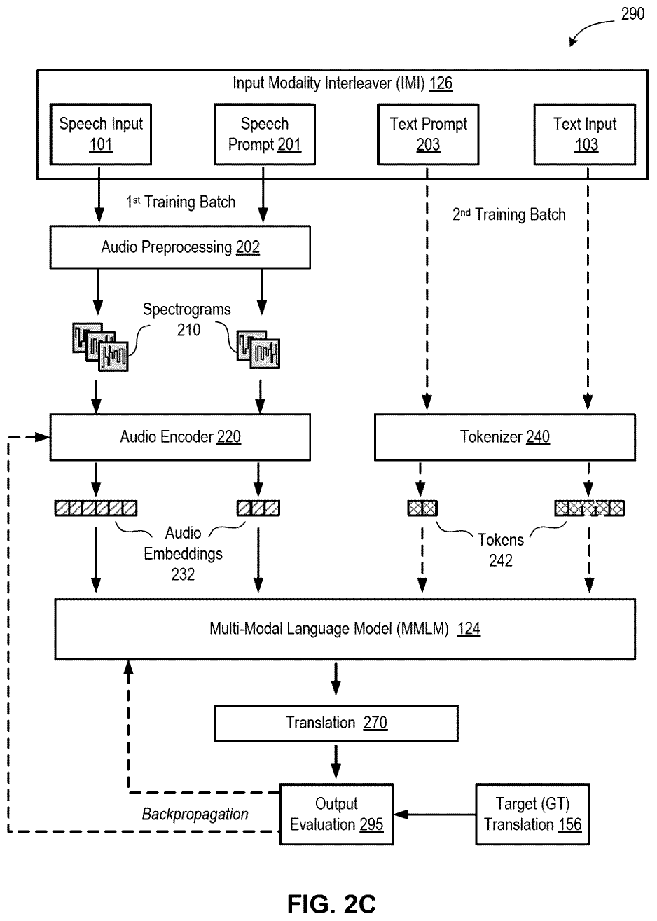

FIG. 2A illustrates example operations 200 of a multi-modal language model 124-A trained using interleaved multi-modal training, according to at least one embodiment. MMLM 124-A may be MMLM 124 of FIG. 1A and/or FIG. 1B. Example operations 200 may be used to process a speech input 101 and/or text input 103 to translate any content included therein from a first language to a second language, which may include any suitable language(s) (e.g., English, Spanish, German, Italian, Arabic, Chinese, etc.) that MMLM 124-A is being trained to understand. Operations 200 may be performed as part of training of an MMLM, e.g., by LM training server 120, and/or as part of deployment of a trained MMLM, e.g., by inference server 102 (with reference to FIG. 1A). Various blocks denoted in FIG. 2A with the same numerals as the respective blocks of FIG. 1A and/or FIG. 1B may implement the same (or a similar) functionality.

Speech input 101 may be captured using one or more audio sensors, e.g., microphones. Microphones can include dynamic microphones, condenser microphones, ribbon microphones, unidirectional microphones, omnidirectional microphones, and/or any other types of microphones. In some embodiments, a microphone can be combined with other devices, e.g., computers, phones, speakers, TV screens, smart kiosks, smart speakers/displays, in-vehicle or in-cabin infotainment or computing devices, and/or the like. The speech input 101 collected by the audio sensors may be generated, e.g., spoken, by any number of speakers and may include a single speech episode or multiple speech episodes. The audio sensors may capture not only a speech signal but also background noise, interference signals, e.g., emitted by TV devices, radio devices, alarm devices, and/or any other equipment, or sounds naturally occurring (e.g., sound of wind, water, birds, etc.).

In some embodiments, in addition to speech input 101, MMLM 124-A may receive a speech prompt 201, which may include any a description of a task to be performed by MMLM 124-A, together with keywords, phrases, contexts, explanations, and/or any other information that may be related to speech input 101.

Speech input 101 and/or speech prompt 201 may undergo audio preprocessing 202. For example, audio preprocessing 202 may include filtering, denoising, amplification, dereverberation, segmentation, and/or any other suitable audio signal enhancement. Audio preprocessing 202 may further include removal of portions of the speech input 101 and/or speech prompt 201 that do not have a speech content. For example, audio preprocessing 202 may evaluate energy e(t) associated with the audio data as a function of time and identify regions that have energy less than a certain threshold (e.g., an empirically determined noise threshold). Such identified regions may be removed (trimmed) from speech input 101 and/or speech prompt 201 during audio preprocessing 202. Segmentation may include segmenting speech input 101 and/or speech prompt 201 into intervals of a predetermined size (duration), τ, e.g., 0.05-5 sec. Such intervals need not correspond to a complete logical unit of speech and may encompass one or more sentences, one or more words, a part of a word, one or more exclamations, filler words, pauses, and/or the like. In some embodiments, the intervals may be partially overlapping.

Individual intervals may be represented via one or more frames, e.g., T frames over a certain predetermined interval of time. Frames may have a duration of 15 msec, 20 msec, 30 msec, 80 msec, and/or some other duration. Frames may undergo a suitable frame-to-spectrogram transformation to generate spectrograms 210. Spectrograms 210 may include any suitable representation of audio data, including (but not limited to) Fourier spectrograms, mel-spectrograms, wavelet spectrograms, time-domain filterbanks, custom filterbanks, learnable filterbanks, custom audio embeddings, and/or other forms of analog or digital intermediate audio representation, or some combination thereof. For example, spectrogram(s) 210 of a frame may be obtained or generated by performing discrete Fourier transforms of acoustic energy e(t) or air pressure p(t) associated with a specific utterance. The obtained spectrograms e(fᵢ) may be defined for a number of bands f₁, f₂ . . . f_{C}, for example, for C=80 bands or C=128 bands, or any other number of bands. In some embodiments, the bands may be mel-bands and the spectrograms may be mel-spectrograms. Separate spectrograms 210 may be obtained for separate audio frames.

Spectrograms 210 may be processed by an audio encoder 220 that represents speech input 101 and/or speech prompt 201 via audio embeddings (features) 230 in a format that can be understood by MMLM 124-A. Audio embeddings 230 generated by the audio encoder 220 may capture temporal and frequency correlations of speech input 101 and/or speech prompt 201. An embedding should be understood as any suitable digital representation of a unit (e.g., frame, portion of a frame, several frames, etc.) of speech input 101 and/or speech prompt 201, e.g., as a vector (string) of any number D of components, which can have integer values or floating-point values. Embeddings can be considered as vectors or points in a D-dimensional embedding space. The dimensionality D of the embedding space can be smaller than the size of the speech input 101 (or spectrograms 210). Audio encoder 220 may be trained to associate similar sets of training audio spectrograms with similar embeddings represented by points closely situated in the embedding space and further learns to associate dissimilar sets of training audio spectrograms with points that are located further apart in the embedding space. A given audio embedding 230 can encode (represent) one or more words, or a portion (e.g., one or more syllables of phonemes) of a word.

In some embodiments, audio encoder 220 may be of a conformer type. The conformer architecture combines elements of transformer networks, e.g., self-attention layers, with elements of convolutional networks, e.g., layers of kernels (filters) that narrow or broaden a field of perception. For example, a conformer network may include a stack of alternating multi-head attention layers, depth-wise separable convolutional layers, and/or fully-connected layers. Some of the layers of a conformer network may be connected with residual (skipped) connections. In some embodiments, a conformer network may include a downsampling module, which may be deployed at the start of the conformer, to modify a frame rate of spectrograms 210, e.g., from the 20 msec interval per frame to the 80 msec interval, in one illustrative example. In some embodiments, a Fast Conformer may be deployed. A Fast Conformer may differ from a conventional conformer in the use of a larger-scale initial downsampling (e.g., 8× downsampling) to reduce computational costs of subsequent attention layers, replace some of the sub-sampling convolutional layers with depthwise separable convolutions, reduce a number of convolutional filters in downsampling block(s) (e.g., to 256), and further reduce a size of convolutional kernel(s), (e.g., to 9). In some embodiments, audio encoder 220 may include a NeMo-type model having 100 M or more learnable parameters, a Canary model, and/or any other suitable model.

Audio embeddings 230 may represent a first input modality-speech modality capable of being processed by MMLM 124-A. A text input 103 and/or text prompt 203 may be processed by a tokenizer 240 that converts text(s) into tokens 242 of a format that is understood by MMLM 124-A. For example, MMLM 124-A may operate in conjunction with a known set of tokens, which may include any suitable representation of units of speech (e.g., syllables, words, etc.) as numbers. In one example of GPT-4 tokens, word “the” may be represented via token “280”, word “import” may be represented via token “476,” word “description” may be represented via token “4097,” and so on. In other embodiments, individual words may be represented using any number of tokens, or word transitions (e.g., end of one word, beginning of next) may be represented using a single token. As such, tokenizing may be performed in any manner that is suitable for use as an input to the network. In some embodiments, units of input text(s) may be represented via flexible-size subwords, e.g., segments of vocabulary words (encountered in training of tokenizer 240) ranging in length from a single character to any portion of a word by grouping frequently encountered individual strings of characters into new tokens, which are then added to the vocabulary. In some embodiments, tokenizer 240 may use a Byte Pair Encoding (BPE) an N-gram model and/or the like.

Text prompt 203 may be used for any purpose (e.g., to provide instructions, context, etc.) that is served by speech prompt 201 and may be used instead of speech prompt 201 or together with speech prompt 201. In some embodiments, any or both of speech prompt 201 and/or text prompt 203 may not be used. In some embodiments, e.g., during training, text prompt(s) 203 may include target translations.

In a speech mode, MMLM 124-A may process speech input(s) 101 and (optionally) speech prompt(s) 201 but not text input(s) 103 or text prompt(s) 203. In a text mode, MMLM 124-A may process text input(s) 103 and (optionally) text prompt(s) 203 but not speech input(s) 101 or speech prompt(s) 201. In a combination (mixed) mode, MMLM 124-A may process both speech input(s) 101 and text input(s) 103 (and, optionally, speech prompt(s) and/or text prompt(s) 203).

In some embodiments, MMLM 124-A may be an encoder-decoder model with an encoder 250 encoding audio embeddings 230 (representative of speech input 101 and/or speech prompt 201) and/or tokens 242 (representative of text input 103 and/or text prompt 203) to form intermediate (hidden) features. Encoder 250 may include one or more attention blocks that compute attention scores between various (e.g., any, some or all) input units including audio embeddings 230 and/or tokens 242. A decoder 260 may then process the hidden features generated by encoder 250 to obtain a translation 270 of speech input 101 and/or text input 103.

In some embodiments, e.g., when MMLM 124-A is used to perform offline translations, audio embeddings 230 and or tokens 242 may represent an entire speech utterance of a particular speech episode or an entire text segment. In some embodiments, audio embeddings 230 may represent a portion of a speech utterance (e.g., several minutes of a speech episode) or a portion of a text segment with translations 270 of different portions of the speech utterance/text segment processed independently, e.g., sequentially. In some embodiments, MMLM 124-A may be used to perform streaming translations. In such embodiments, embeddings 230 and or tokens 242 may represent a certain sliding window of an empirically set duration τ, e.g., several seconds or more or a certain number of consecutive words or characters, e.g., 3-10 words. Consecutive sliding windows may be non-overlapping or overlapping over some predetermined time or some number of words/characters at the beginning/end of the intervals. In such embodiments, individual translations 270 may be generated for consecutive sliding windows and subsequently aggregated and displayed on a UI, stored/transmitted over a network, and/or used in any other suitable manner.

FIG. 2B illustrates example operations 280 of another multi-modal language model 124-B trained using interleaved multi-modal training, according to at least one embodiment. As illustrated in FIG. 2B, MMLM 124-B may include a cross-attention network 255, e.g., a transformer-based cross-attention network, and a decoder 260. While the MMLM 124-A illustrated in FIG. 2A may process speech input(s) 101 (and/or speech prompt(s) 201) that are concatenated to text input(s) 103 (and/or text prompt(s) 203), MMLM 124-B may apply cross-attention between speech input(s) 101 (and/or speech prompt(s) and text prompts 203 (which, in training, may include target translations). For example, the cross-attention may use tokens of text prompt 203 as attention queries and may use audio embeddings 230 of speech input 101 as attention keys and values.

FIG. 2C illustrates example operations 290 of training a multi-modal language model 124 using interleaved multi-modal training, according to at least one embodiment. The MMLM 124, whose training is illustrated with FIG. 2C, may be MMLM 124-A disclosed in conjunction with FIG. 2A and/or MMLM 124-B disclosed in conjunction with FIG. 2B. In at least one embodiment, MMLM 124 may be trained by training engine 122 of LM training server 120 and subsequently uploaded to inference server 102 (with reference to FIG. 1A). Various blocks denoted in FIG. 2C with the same numerals as the respective blocks of FIG. 2A and/or FIG. 2B may implement the same (or a similar) functionality.

Input modality interleaver (IMI) 126 may interleave input data of different modalities, e.g., by selecting (e.g., randomly) speech input(s) 101 or test input(s) 103 into a particular batch of a randomly selected modality. For example, as indicated, a first training batch may include speech inputs and a second training batch may include text inputs. Further training batches may likewise be randomly selected from the two (or more, if applicable) modalities. In training, speech input(s) 101 and/or speech prompt(s) 201 may be processed using audio preprocessing 202 and audio encoder 220, and text input(s) 103 and/or text prompt(s) 203 may be processed using tokenizer 240, e.g., as disclosed above in conjunction with FIG. 2A, before being processed by MMLM 124. MMLM 124 may process the input data, which may be in a first language, and generate a translation 270 in a second language. Translation 270 may be compared with a target (ground truth or GT) translation 156 by an output evaluation 295 function (which may include one or more loss functions, e.g., loss function 170, with reference to FIG. 1A). The difference between the MMLM-generated translation 270 and the target translation 156 may be used to modify parameters of MMLM 124, e.g., weights and biases of the encoder network, decoder network, cross-attention network, classifiers, and/or any other architectural components of MMLM 124. For example, modification of parameters may be performed using various algorithms of backpropagation, gradient descent, and/or other training techniques.

In some embodiments, MMLM 124 may be pre-trained in various foundational language tasks (e.g., next/previous word prediction, intent/sentiment identification, and/or the like). In some embodiments, target translation(s) 156 may also be included directly as part of text prompt(s) 203.

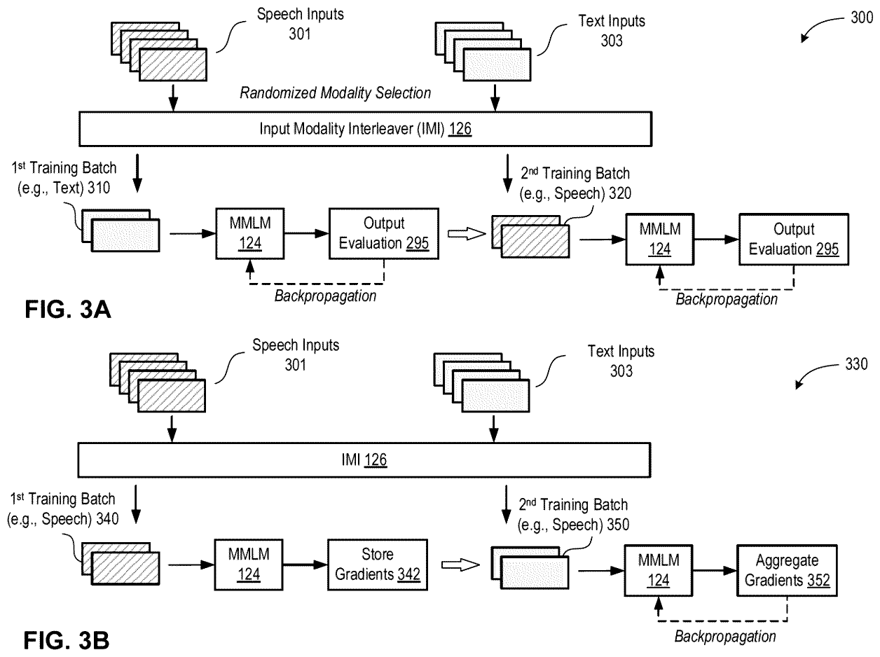

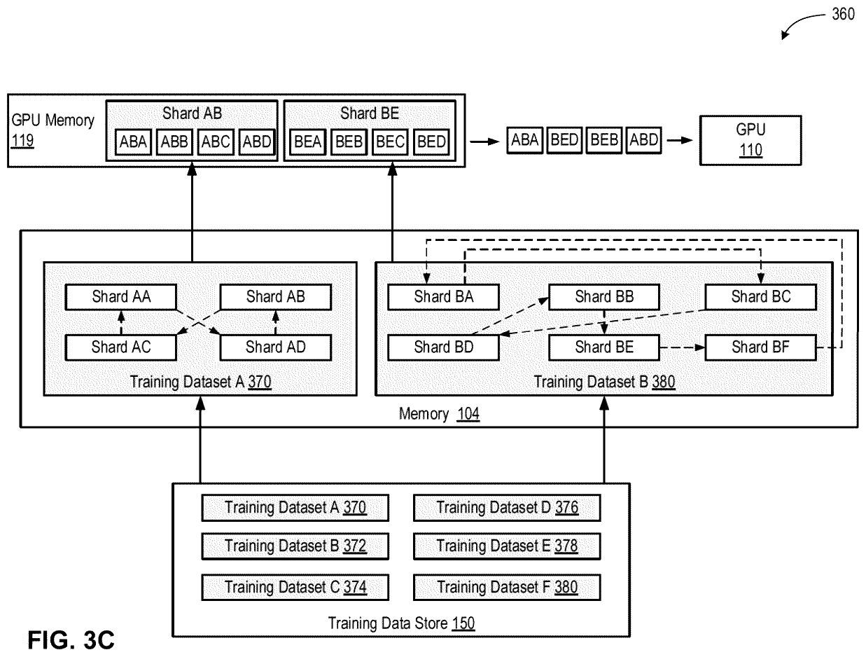

FIGS. 3A-3B illustrate example operations of interleaved multi-modal training, according to at least one embodiment. Operations illustrated in FIGS. 3A-3B may be performed by training engine 122 using input modality interleaver (IMI) 126. FIG. 3A illustrates example operations 300 of interleaved multi-modal training with random selection of input modalities, according to at least one embodiment. IMI 126 may have access to training data of multiple modalities, e.g., speech inputs 301 and text inputs 303. IMI 126 may form batches of training data. A batch of training data may be processed by MMLM 124 in a single setting, e.g., by forming a tensor that includes one or more inputs. The number of such inputs may depend on sizes of the inputs, e.g., as disclosed in more detail below in conjunction with FIG. 4A. IMI 126 may randomly select a modality data for different training batches. For example, if training data includes N_{SPEECH} training batches of speech modality and N_{TEXT} training batches of text modality, IMI 126 may (initially) assign a probability P_{SPEECH}=N_{SPEECH}|(N_{TEXT}+N_{SPEECH}) of selecting a speech batch and a probability P_{TEXT}=N_{TEX}T/(N_{TEXT}+N_{SPEECH}) of selecting a text batch. IMI 126 may randomly select a first training batch 310 (e.g., of text modality) for processing by MMLM 124 based on the assigned probabilities, e.g., using a binomial distribution (a multinomial distribution, if data of more than two modalities is available). In some embodiments, first training batch 310 may include text inputs 303 (e.g., one or more texts in a first language) and target translations (e.g., in a second language). An output of MMLM 124 may be compared with a target translation using an output evaluation 295 function (which may include one or more suitable loss functions). Following processing of the first training batch 310, output evaluation 295 may compute gradients for various neuron parameters (e.g., weights and biases) of MMLM 124 and modify these neuron parameters using the computed gradients and various techniques of backpropagation, gradient descent, and/or the like.

Similarly, IMI 126 may then randomly select a second training batch 320 (e.g., of speech modality) for processing by MMLM 124. In some embodiments, second training batch 320 may include speech inputs 301 (e.g., one or more utterances in the first language) and target translations (e.g., text translations in a second language). An output of MMLM 124 may be compared with a target translation using an output evaluation 295 function (which may include one or more suitable loss functions) and the results of the evaluation may be used to modify one or more parameters of MMLM 124 using backpropagation, gradient descent, and/or the like.

As a given training epoch progresses, and one of the modalities of training data may be consumed (e.g., probabilistically, as a result of other modalities being sampled more often), the probabilities of selection of the remaining training data may be adjusted accordingly. For example, the probability of speech input selection, P_{SPEECH}=N_{SPEECH}/(N_{TEXT}+N_{SPEECH}) (and similarly for other modalities, e.g., P_{TEXT}=1−P_{SPEECH}) may be determined on a running basis after one or more training batches have been processed. Correspondingly, if one of the modalities is sampled more frequently, the rate of sampling that modality may be reduced, and vice versa.

FIG. 3B illustrates example operations 330 of interleaved multi-modal training with aggregation of modifications of model parameters, according to at least one embodiment. In some embodiments, IMI 126 may establish and maintain a deterministic or random schedule of selection of batches of training data. For example, IMI 126 may select a first training batch 340 (e.g., of speech modality), a second training batch 350 (e.g., of text modality), and/or the like. Following processing of first training batch 340, the output evaluation (not shown in FIG. 3B) may compute (e.g., as disclosed above) modifications, e.g., gradients, of parameters of MMLM 124 and store gradients (at block 342) for later use. Subsequently, one or more additional training batches may be processed, e.g., a second training batch 350, and additional modifications to the parameters of MMLM may be computed, and so on. Various gradients computed for multiple training batches may then be aggregated (e.g., added) and applied to the parameters of the MMLM (at block 352)

FIG. 3C illustrates one illustrative example of training data randomization 360 that may be performed as part of training of MMLMs and other AI models, according to at least one embodiment. Training data store 150 may store any number of training datasets 370-380. An individual training dataset may include multiple units of training data, which may be used to assemble training batches, e.g., first training batch 310, second training batch 320, and/or the like (with reference to FIG. 3A). Randomly selecting units of training datasets 370-380 for loading into (system) memory 104 from training data store 150 may be a slow process. To facilitate a fast randomized selection of training units, one or more datasets may be loaded into memory 104, e.g., training dataset A 370 and training dataset B 380, in one illustrative example. Individual training datasets may be stored as multiple shards (which may be of equal or approximately equal sizes). For example, training dataset A may include four shards, e.g., shards AA, AB, AC, and AD (with the first letter indicating a training dataset and the second letter indicating a shard of the respective training dataset), and training dataset B may include six shards, e.g., shards BA, BB, BC, BD, BE, and BF.

At the start of a training epoch, shards of a given training dataset may be randomly shuffled, e.g., as illustrated in FIG. 3C with dashed arrows. Subsequently some number of shards, e.g., shard AB and shard BE may be loaded to GPU memory 119. Each shard may include any number of training data units, e.g., ABA, ABB, and so on (with the first two letters indicating a shard and the third letter indicating a unit of the respective shard). The training data units loaded into GPU memory 119 may then be randomly selected to form training batches that are processed by GPU 110 (and/or other suitable processing devices). After training data units of the loaded shards have been assembled into training batches and processed by GPU 110, a new set of shards may be loaded into GPU memory 119 from memory 104. Since different shards in the training datasets loaded into memory 104 have previously been randomly shuffled, loading shards into GPU memory 119 may be performed in an arbitrary, e.g., deterministic, order.

FIG. 4A illustrates training data size binning 400 that may be used in interleaved multi-modal training, according to at least one embodiment. Training data size binning 400 may be performed by a training data binning (TBD) engine 128. Training inputs of different sizes (e.g., number of words of text inputs, duration of speech inputs, and/or the like) may be distributed among a set of bins such that training inputs associated with a particular bin may have an approximately equal (or substantially similar) length, to reduce an amount of processing of null inputs (e.g., used to pad various inputs in a given batch to a common size). In some embodiments, the binning may be performed in a two-dimensional training data size space of an input size 410 and output size 420. In some embodiments, output sizes 420 may be known, e.g., from available target (ground truth) outputs. In some embodiments, output sizes 420 may be estimated, e.g., based on input size 410 of the corresponding inputs.

Bins may be defined in any suitable manner, with an individual bin associated with a particular portion of the training data size space. Non-limiting example rectangular bins 0-23 are shown in FIG. 4A, but bins of any other sizes and shapes may be similarly defined. In some embodiments, training data may be assigned to individual bins in such a way that the differences in sizes along different directions of the training data size space between the longest training data and the shortest training data in a bin does not exceed predefined tolerances ΔX, ΔY, e.g., X_{MAX}−X_{MIN}≤ΔX; Y_{MAX}−Y_{MIN}≤ΔY. As a result, TDB engine 128 may form bins Bᵢⱼ in a two-dimensional space of input sizes j and target sizes k such that batches of training data are formed from inputs and target outputs of similar dimensions, to minimize padding and processing of padded portions of the input data.

FIG. 4B illustrates batch size optimization 450 that may be used in interleaved multi-modal training, according to at least one embodiment. Batch size optimization 450 may be performed by a batch size optimization (BSO) engine 132. In some embodiments, BSO engine 132 may perform batch size optimization 450 based on bins determined as part of operations disclosed in conjunction with FIG. 4A. Batch size optimization 450 may be performed to identify optimal sizes of training batches, e.g., for various individual bins, with estimated hardware utilization being close to a target utilization (e.g., 90%, 95%, 98%, and/or the like) yet not likely to exceed such target utilization.

Fewer units of training data classified into bins with longer inputs/outputs may fit into a training batch that can be processed by a given hardware without overutilizing the hardware's resources. Determining an optimal amount of training data (e.g., number of inputs/outputs) from a particular bin B that can be included into an individual batch may be determined using simulations. For example, BSO engine 132 may use a random tensor generator 460 to select, for a test run, a number N₁ of dummy units of a size determined by the bin B. Dummy units may be randomly filled with dummy data and—being added to a dummy batch—run on a processing device by tensor processing 470 in a normal fashion, e.g., with the forward pass, loss function computation, backward pass, parameter update, and/or other operations being performed. In some embodiments, tensor processing 470 may deploy a TensorFlow® backend, PyTorch® backend, TensorRT® backend, ONNX® backend, Keras® backend, and/or the like. Various resource utilization metrics 480 may be measured to determine whether the hardware is underutilized or overutilized. For example, resource utilization metrics 480 may include a fraction of available GPU memory being used, a fraction of available number of processor (e.g., GPU, CPU, PPU, and/or the like) clock cycles being used, and/or the like.

If the hardware is underutilized (e.g., a portion of GPU memory remains unused, a GPU is operating at less than maximum frequency of clock cycles, etc.), another dummy batch may be formed with N₂=αN₁ dummy units (with the increment factor α>1 selected based on field testing) and used in the next test run, Nₖ₊₁=αNₖ, and so on. Once hardware overutilization is detected (e.g., GPU memory is overflowing, GPU processing is performed at the maximum rate, etc.) during run k, the number of dummy units in the next run may be decreased, e.g., Nₖ₊₁=Nₖ(1−α/2). This process may continue with the BSO engine 132 choosing progressively finer increments/decrements ±α/n to find the optimal size of a training batch for which an estimated hardware utilization is close to a target utilization. The output of the batch size optimization 450 may include a bin-to-batch size mapping 490. Bin-to-batch size mapping 490 may then be used in processing of real training inputs, e.g., as disclosed in conjunction with FIG. 3A and/or FIG. 3B.

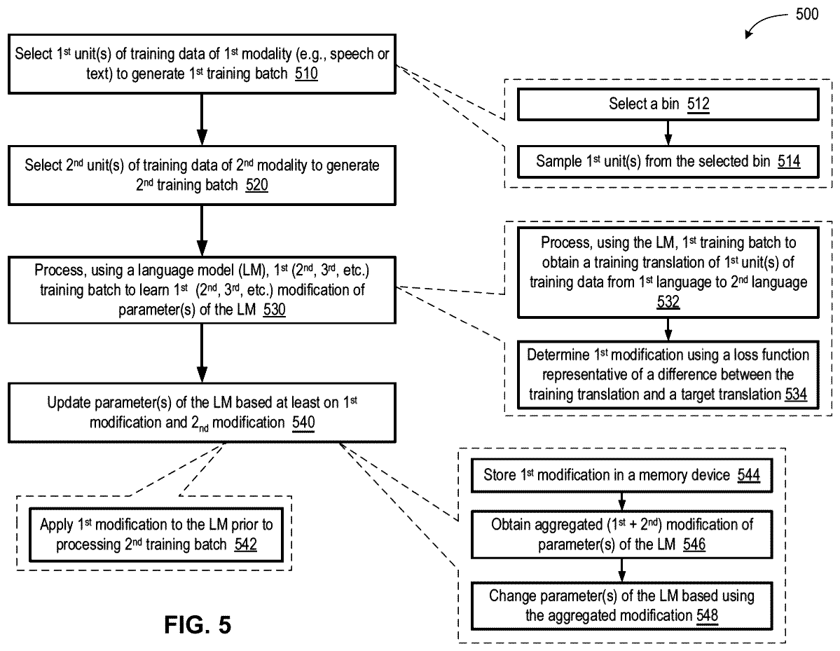

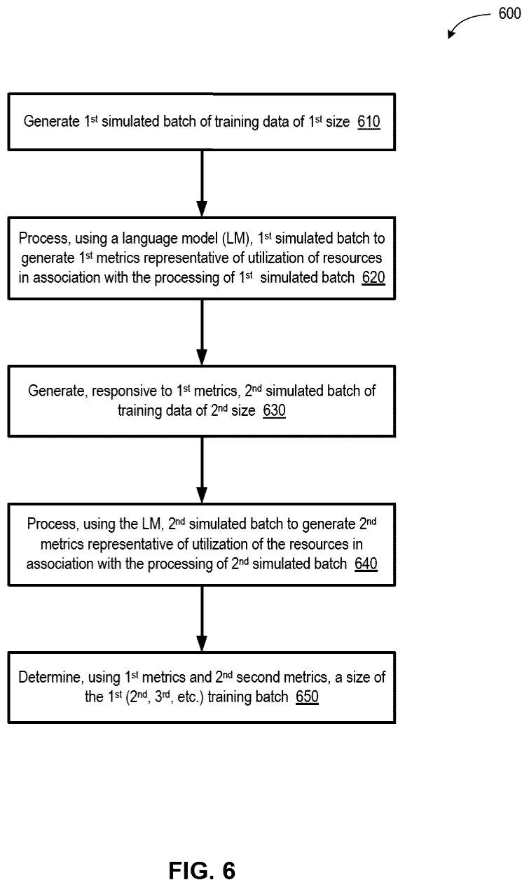

FIG. 5 and FIG. 6 are flow diagrams of respective methods 500 and 600 that facilitate training of multi-modal language models, according to at least one embodiment. Methods 500 and/or 600 may be performed using one or more processing units (e.g., CPUs, GPUs, accelerators, PPUs, DPUs, etc.), which may include (or communicate with) one or more memory devices. In at least one embodiment, methods 500 and/or 600 may be performed using processing units of LM training server 120 of FIG. 1A. In at least one embodiment, processing units performing any of methods 500 and/or 600 may be executing instructions stored on a non-transient computer-readable storage media. In at least one embodiment, any of methods 500 and/or 600 may be performed using multiple processing threads (e.g., CPU threads and/or GPU threads), with individual threads executing one or more individual functions, routines, subroutines, or operations of the methods. In at least one embodiment, processing threads implementing any of methods 500 and/or 600 may be synchronized (e.g., using semaphores, critical sections, and/or other thread synchronization mechanisms). Alternatively, processing threads implementing any of methods 500 and/or 600 may be executed asynchronously with respect to each other. Various operations of any of methods 500 and/or 600 may be performed in a different order compared with the order shown in FIG. 5 and FIG. 6. Some operations of any of methods 500 and/or 600 may be performed concurrently with other operations. In at least one embodiment, one or more operations shown in FIG. 5 and/or FIG. 6 may not always be performed.

Methods 500 and/or 600 may be performed in the context of speech-to-text applications, chatbot applications, audio applications, video applications (including streaming audio and/or video applications), gaming applications, digital assistant applications, video conferencing applications, audio conversation applications, audio/text messaging applications, and/or any other suitable applications that use speech-to-text and/or text-to-text translations. Methods 500 and/or 600 may involve speech utterances produced by people in any possible context, e.g., a conversation, a public speech, a public event, a business meeting, a conference, a street encounter, an interaction in a game, an interaction with a chatbot or digital avatar, an interaction with an in-vehicle infotainment system, and/or the like. “Speech,” as used in the context of methods 500 and/or 600 should be understood as including sounds produced by humans as well as robotic speech, e.g., a synthesized or computer-generated speech, and/or the like.

FIG. 5 is a flow diagram of an example method 500 of using interleaved multi-modal training for training of language models, according to at least one embodiment. Operations of method 500 may be performed by processing unit(s) of LM training server 120 of FIG. 1A, e.g., as part of training of MMLM 124 or other suitable LM models (or AI models different from LM models). Operations of method 500 may be performed using training data of a first modality (e.g., speech or text) and a second modality (e.g., text or speech). In some embodiments, method 500 may be performed to train any AI model with two or more different modalities, e.g., text, speech, images (including video), facial animations, and/or the like. In some embodiments, prior to training an AI model, method 500 may include establishing a plurality of bins. An individual bin of the plurality of bins may be associated (e.g., as illustrated in FIG. 4A) with (i) a corresponding first size range of input data units and (ii) a corresponding second size range of output data units.

At block 510, one or more processing units executing method 500 may select one or more first units of training data of a first modality to generate a first training batch (e.g., first training batch 310 in FIG. 3A). In some embodiments, as illustrated with the top callout portion in FIG. 5, selecting the one or more first units of training data may include, at block 512, selecting a bin from the plurality of bins and, at block 514, selecting the one or more first units of training data in association with the selected bin. In some embodiments, the one or more first units of training data are probabilistically selected based at least on an amount of training data of the first modality.

At block 520, method 500 may continue with selecting one or more second (third, etc.) units of training data of a second (third, etc.) modality to generate a second (third, etc.) training batch. At block 530, method 500 may include processing, using an LM, the first training batch to learn a first modification of one or more parameters of the LM. Similarly, operations of block 530 may include processing the second (third, etc.) training batch to learn a second modification of the one or more parameters of the LM.

In some embodiments, processing the first (second, etc.) training batch to learn the first (second, etc.) modification of the one or more parameters of the LM may include operations illustrated with the middle callout portion of FIG. 5. More specifically, at block 532, method 500 may include processing, using the LM, the first (second, etc.) training batch to obtain a training translation of the one or more first (second, etc.) units of training data from a first language to a second language. At block 534, method 500 may continue with determining the first modification based at least on a loss function (e.g., loss function 170 in FIG. 1B) representative of a difference between the training translation and a target translation of the one or more first units of training data.

At block 540, method 500 may include changing the one or more parameters of the LM based at least on the first modification and the second modification. In some embodiments, changing the one or more parameters of the LM may include operations illustrated with the bottom callout portions of FIG. 5. More specifically, at block 542, operations of method 500 may include applying the first modification to the LM prior to the processing of the second training batch (e.g., as illustrated in FIG. 3A). In some embodiments, changing the one or more parameters of the LM may include storing, at block 544, the first modification in a memory device (e.g., as illustrated with block 342 in FIG. 3B). Operations of method 500 in such instances may include, as shown in block 546, aggregating, subsequent to the processing the second (third, etc.) training batch, the first modification with the second modification to obtain an aggregated modification of the one or more parameters of the LM, e.g., as illustrated with block 352 in FIG. 3B). At block 548, operations of method 500 may continue with changing the one or more parameters based on at least the aggregated modification.

FIG. 6 is a flow diagram of an example method 600 of batch size optimization that may be used in interleaved multi-modal training, according to at least one embodiment. One or more operations of method 600 may be performed by processing units of LM training server 120 of FIG. 1A. At block 610, method 600 may include generating a first simulated batch of training data, the first simulated batch having a first size. At block 620, method 600 may continue with processing, using the LM (or some other AI mode), the first simulated batch to generate one or more first metrics representative of utilization of resources in association with the processing of the first simulated batch. In some embodiments, the one or more first metrics may be representative of utilization of at least a memory of a graphics processing unit (GPU) during processing of the first simulated batch. In one example embodiments, the one or more first metrics may indicate underutilization (or overutilization) of the resources in association with the processing of the first simulated batch.

At block 630, method 600 may continue with generating, responsive to the one or more first metrics, a second simulated batch of training data, the second simulated batch having a second size. For example, if the first metrics indicate underutilization (overutilization) of the resources, the second size may be larger (smaller) than the first size.

At block 640, method 600 may continue with processing, using the LM, the second simulated batch to generate one or more second metrics representative of utilization of the resources in association with the processing of the second simulated batch. In one example embodiments, the one or more second metrics may indicate overutilization (underutilization) of the resources in association with the processing of the second simulated batch.

At block 650, method 600 may include determining, based at least on the one or more first metrics and the one or more second metrics, a size of the first training batch. The sizes of the training batches used in method 500 (e.g., the first training batch, the second training batch, etc.) may be estimated, based at least on the one or more first metrics and the one or more second metrics, to be associated with a target utilization of the resources during processing of the first training batch). For example, a number of consecutive iterations may be performed with the size of the subsequent (e.g., third, fourth, etc.) simulated training batches changed by gradually diminishing amounts (e.g., as disclosed in more detail in conjunction with FIG. 4B) to converge on the target utilization of the resources, e.g., as may be represented by the metrics of the simulated training batches approaching the target utilization.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, analytics operations, factory operations, generation and/or presentation of augmented reality (AR), virtual reality (VR), mixed reality (MR), etc., robotics operations, medical operations, security and surveillance (e.g., in a smart cities embodiment), autonomous or semi-autonomous machine applications, deep learning, environment simulation, object or actor simulation and/or digital twinning, data center processing, generative AI operations, conversational AI operations, operations involving vision language models, large language models, small language models, multi-modal language models, light transport simulations (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), and in-vehicle infotainment system for an autonomous or semi-autonomous machine, systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, SLMs, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, SLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NV Link Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CU DA core precisions of FP64, FP32, FP16, and BF16.

Although examples may be described herein with respect to using machine learning models, such as neural networks or language models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

### INFERENCE AND TRAINING LOGIC

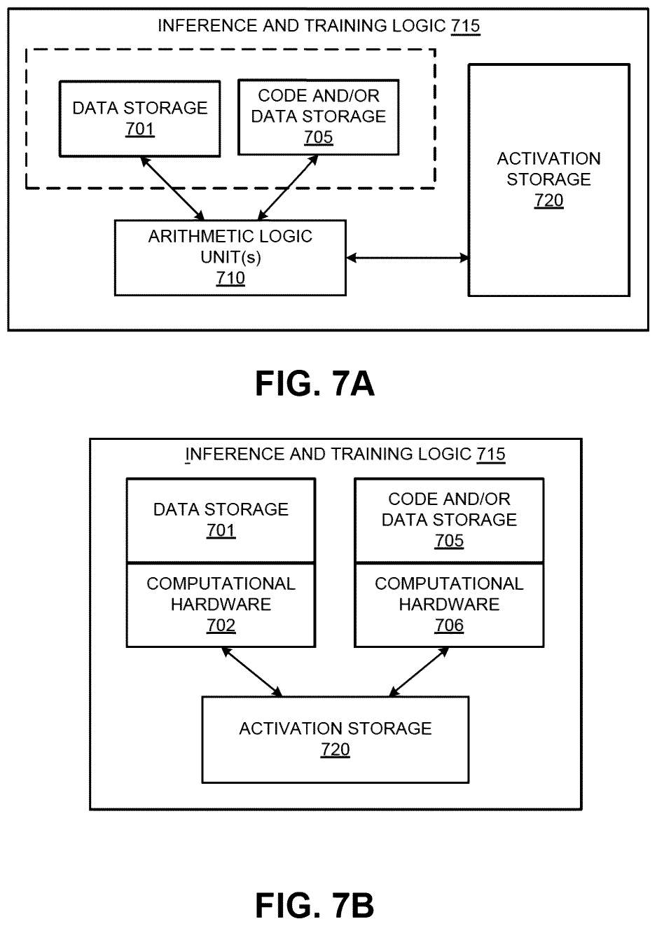

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALU s based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

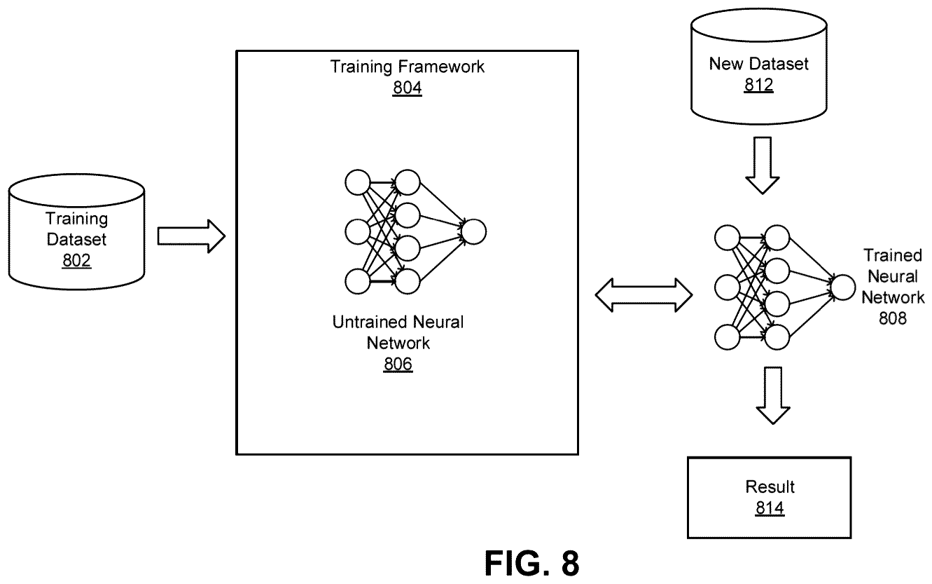

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MX Net, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

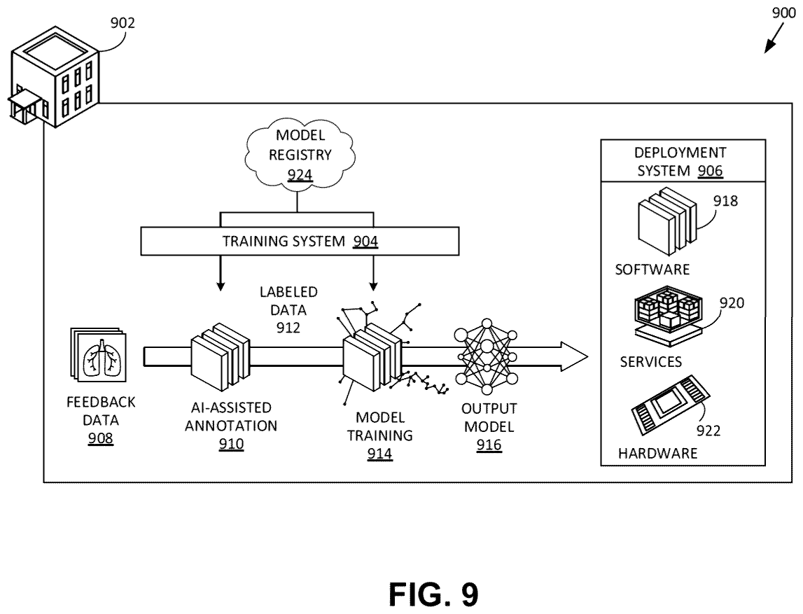

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

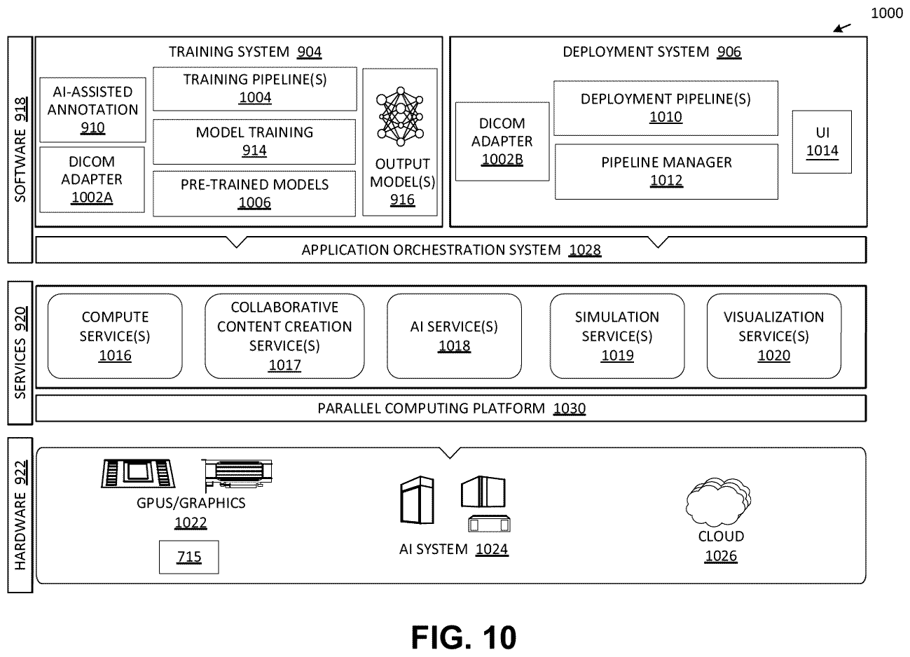

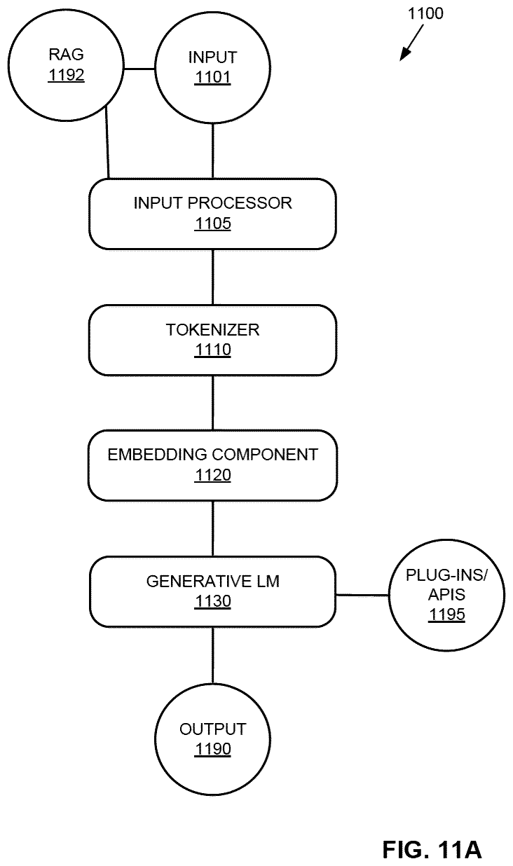

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multi-modal LLMs may be implemented to accept, understand, and/or generate text along with other types of content like images, audio, and/or video. For example, vision language models (VLMs), or more generally multi-modal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs—such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. patent application Ser. No. 18/304,341, filed on Apr. 20, 2023, the contents of which are hereby incorporated by reference in their entirety. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/etc. of the present disclosure may be less likely to output language/text/audio/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, whereat least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

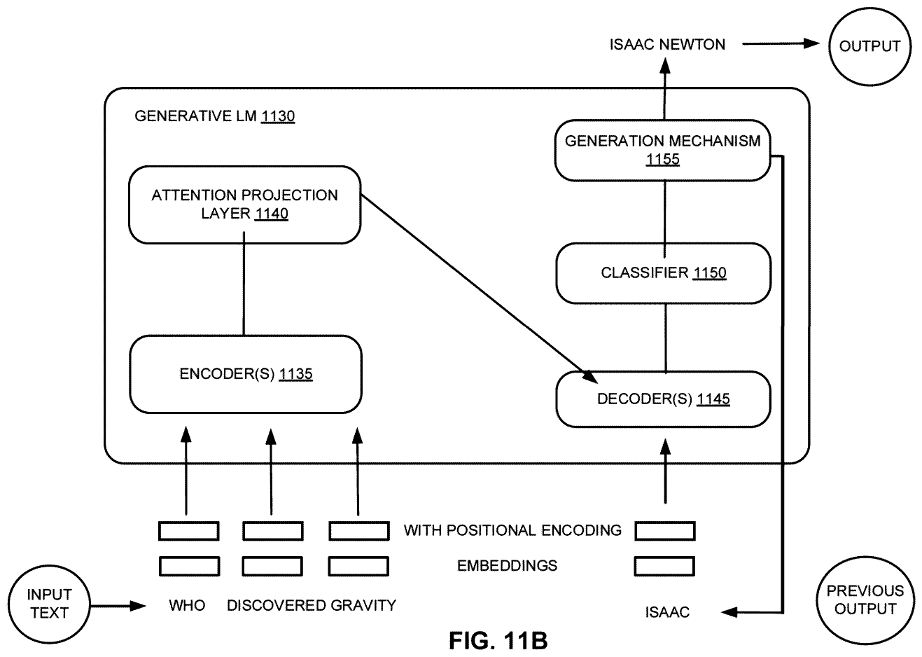

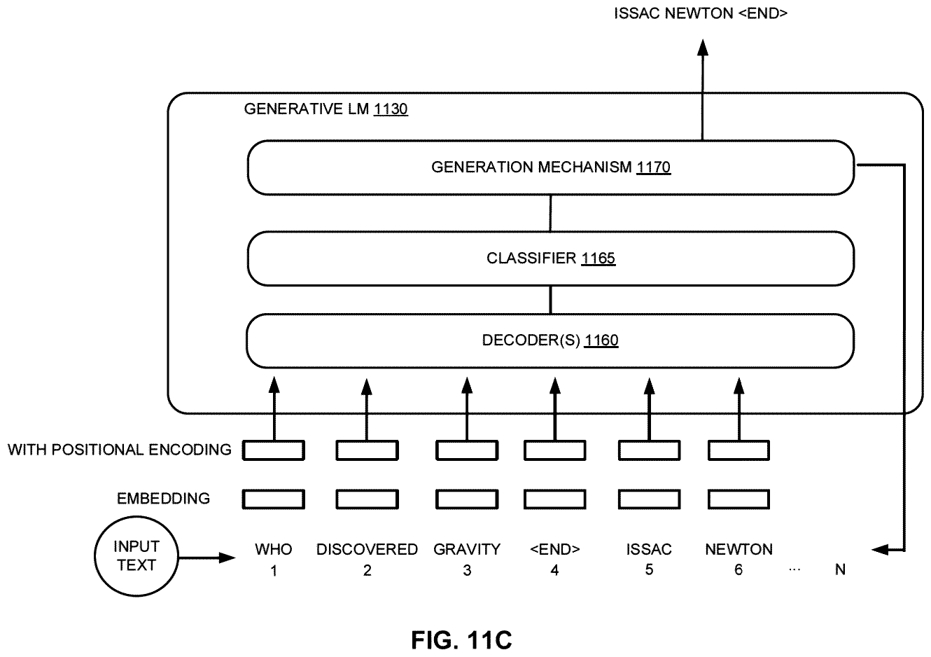

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a SLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/SLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/SLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-ID F) encoding, one or more embedding layers of a neural network, and/or otherwise.

In some embodiments in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features—such as in the form of a spectrogram, which is to be understood to include Fourier spectrograms, mel-spectrograms, wavelet spectrograms, time-domain filterbanks, custom filterbanks, learnable filterbanks, custom audio embeddings, and/or other forms of analog or digital intermediate audio representation, or a combination thereof. In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use- or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example embodiment in which the generative LM 1130 includes a transformer encoder-decoder suitable for use in implementing at least some embodiments of the present disclosure. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture suitable for use in implementing at least some embodiments of the present disclosure. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

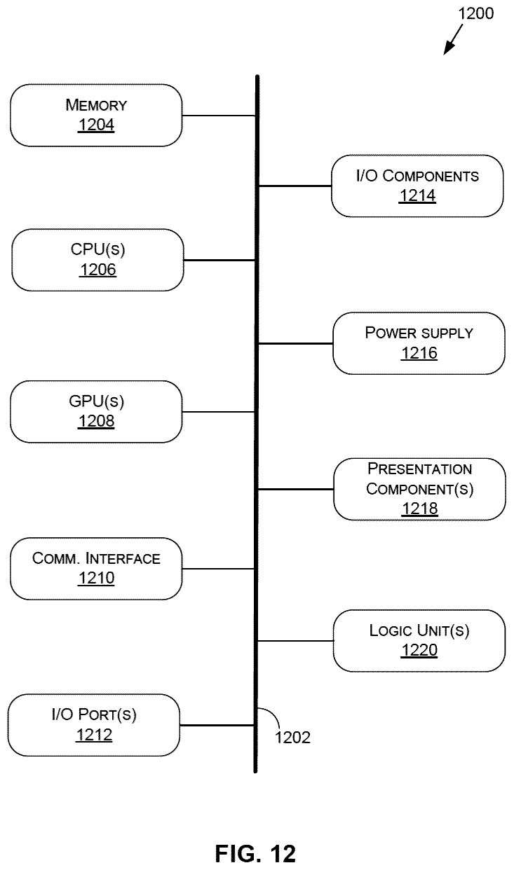

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPU s 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DV D) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU (s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU (s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU (s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU (s) 1206. The GPU (s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU (s) 1208 may generate pixel data for output images in response to rendering commands (e.g., rendering commands from the CPU (s) 1206 received via a host interface). The GPU (s) 1208 may include graphics memory, such as display memory, for storing pixel data or any other suitable data, such as GPGPU data. The display memory may be included as part of the memory 1204. The GPU (s) 1208 may include two or more GPU s operating in parallel (e.g., via a link). The link may directly connect the GPUs (e.g., using NV LINK) or may connect the GPUs through a switch (e.g., using NV Switch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU (s) 1206 and/or the GPU (s) 1208 and/or one or more of the logic units 1220 may be discrete components or otherwise external to the CPU (s) 1206 and/or the GPU (s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IM U)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU (s) 1208, the CPU (s) 1206, DPUs, etc.), and output the data (e.g., as an image, video, sound, etc.).

### Example Data Center

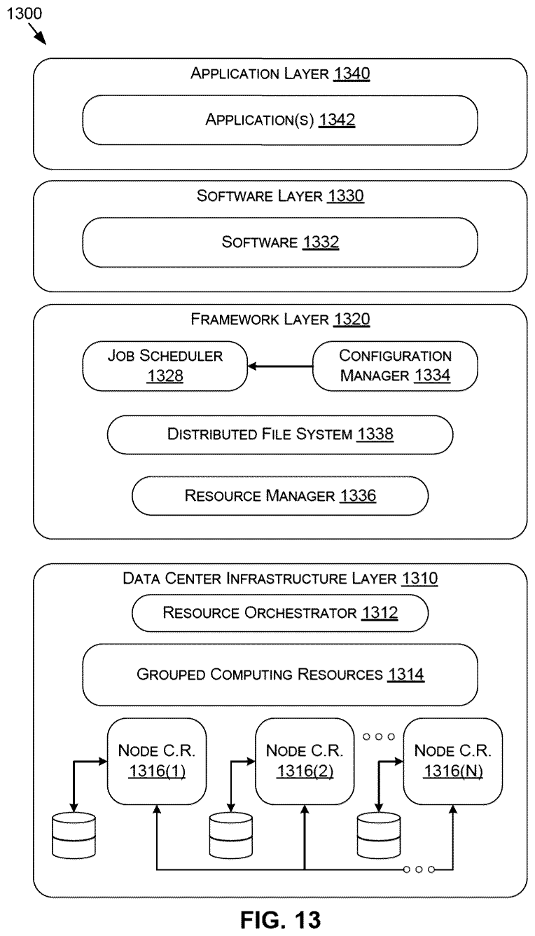

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NWI/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. A Iso, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
selecting one or more first units of training data of a first modality to generate a first training batch;
selecting one or more second units of training data of a second modality to generate a second training batch;
processing, using a language model (LM), the first training batch to learn a first modification of one or more parameters of the LM;
processing, using the LM, the second training batch to learn a second modification of the one or more parameters of the LM; and
updating the one or more parameters of the LM based at least on the first modification and the second modification.

2. The method of claim 1, wherein the first modality comprises a text modality and the second modality comprises a speech modality.

3. The method of claim 1, wherein the processing the first training batch to learn the first modification of the one or more parameters of the LM comprises:
processing, using the LM, the first training batch to obtain a training translation of the one or more first units of training data from a first language to a second language; and
determining the first modification based at least on a loss function representative of a difference between the training translation and a target translation of the one or more first units of training data.

4. The method of claim 1, wherein the updating the one or more parameters of the LM comprises:
applying the first modification to the LM prior to the processing of the second training batch.

5. The method of claim 1, wherein the one or more first units of training data are probabilistically selected based at least on a remaining amount of training data of the first modality.

6. The method of claim 1, wherein the updating the one or more parameters of the LM comprises:
storing the first modification in a memory device;
aggregating, subsequent to the processing the second training batch, the first modification with the second modification to obtain an aggregated modification of the one or more parameters of the LM; and
updating the one or more parameters based on at least the aggregated modification.

7. The method of claim 1, further comprising:
establishing a plurality of bins, an individual bin of the plurality of bins associated with (i) a corresponding first size range of input data units and (ii) a corresponding second size range of output data units,
wherein the selecting the one or more first units of training data comprises:
selecting a bin from the plurality of bins; and
selecting the one or more first units of training data in association with the selected bin.

8. The method of claim 1, further comprising:
generating a first simulated batch of training data, the first simulated batch having a first size;
processing, using the LM, the first simulated batch to generate one or more first metrics representative of utilization of resources in association with the processing of the first simulated batch;
generating, responsive to the one or more first metrics, a second simulated batch of training data, the second simulated batch having a second size;
processing, using the LM, the second simulated batch to generate one or more second metrics representative of utilization of the resources in association with the processing of the second simulated batch; and
determining, based at least on the one or more first metrics and the one or more second metrics, a size of the first training batch.

9. The method of claim 8, wherein the one or more first metrics indicate underutilization of the resources in association with the processing of the first simulated batch, and wherein the one or more second metrics indicate overutilization of the resources in association with the processing of the second simulated batch.

10. The method of claim 8, wherein the one or more first metrics are representative of utilization of at least a memory of a graphics processing unit (GPU) during processing of the first simulated batch.

11. The method of claim 8, wherein the size of the first training batch is estimated, based at least on the one or more first metrics and the one or more second metrics, to be associated with a target utilization of the resources during processing of the first training batch.

12. A method comprising:
generating a first simulated batch of training data, the first simulated batch having a first size;
processing, using an artificial intelligence (AI) model, the first simulated batch to generate one or more first metrics representative of utilization of resources in association with the processing of the first simulated batch;
generating, responsive to the one or more first metrics, a second simulated batch of training data, the second simulated batch having a second size;
processing, using the AI model, the second simulated batch to generate one or more second metrics representative of utilization of the resources in association with the processing of the second simulated batch;
determining, based at least on the one or more first metrics and the one or more second metrics, a size of a training batch of data; and
training the AI model using one or more training batches of data corresponding to the determined size.

13. The method of claim 12, wherein the training the AI model using one or more training batches of data comprises:
processing, using the AI model (LM), the one or more training batches of data to learn a first modification of one or more parameters of the AI model, the one or more training batches of data comprising data of a first modality;
processing, using the AI model (LM), one or more additional training batches of data to learn a second modification of the one or more parameters of the AI model, the one or more additional training batches of data comprising data of a second modality; and
updating the one or more parameters of the AI model based at least on the first modification and the second modification.

14. The method of claim 13, wherein the first modality comprises a text modality and the second modality comprises a speech modality.

15. A system comprising:
one or more processors to:
process, using a language model (LM), a text-modality training batch to learn a first modification of one or more parameters of the LM;
process, using the LM, a speech-modality training batch to learn a second modification of the one or more parameters of the LM; and
update the one or more parameters of the LM based at least on the first modification and the second modification.

16. The system of claim 15, wherein the text-modality training batch comprises one or more units of text-modality data probabilistically selected based at least on an amount of text-modality data in a training dataset.

17. The system of claim 15, wherein to update the one or more parameters of the LM, the one or more processors are to:
apply the first modification to the LM prior to the processing of the second training batch.

18. The system of claim 15, wherein to update the one or more parameters of the LM, the one or more processors are to:
store the first modification in a memory device;
aggregate, subsequent to the processing the second training batch, the first modification with the second modification to obtain an aggregated modification of the one or more parameters of the LM; and
update the one or more parameters based on at least the aggregated modification.

19. The system of claim 15, wherein the one or more processors are further to:
generate a first simulated batch of training data, the first simulated batch having a first size;
process, using the LM, the first simulated batch to generate one or more first metrics representative of utilization of resources in association with the processing of the first simulated batch;
generating, responsive to the one or more first metrics, a second simulated batch of training data, the second simulated batch having a second size;
process, using the LM, the second simulated batch to generate one or more second metrics representative of utilization of the resources in association with the processing of the second simulated batch; and
determine, based at least on the one or more first metrics and the one or more second metrics, a size of the first training batch.

20. The system of claim 15, wherein the system is comprised in at least one of:
an in-vehicle infotainment system for an autonomous or semi-autonomous machine;
a system for performing one or more simulation operations;
a system for performing one or more digital twin operations;
a system for performing light transport simulation;
a system for performing medical operations;
a system for performing factory operations;
a system for performing collaborative content creation for 3D assets;
a system for performing one or more wireless cellular transmissions using a wireless cellular network;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models (MMLMs);
a system implementing one or more vision-language-action (VLA) models;
a system implemented using an inference microservice that includes an operating-system (OS) level virtualization package and one or more machine learning models;
a system for performing one or more generative AI operations;
a system for generating synthetic data;
a system incorporating one or more virtual machines (VMs);
a system implemented at least partially in a data center; or
a system implemented at least partially using cloud computing resources.
